(19) United States
(12) Patent Application Publication
(10) Pub. No.: US 2019/0056068 A1
(43) Pub. Date: Feb. 21, 2019

(54) LAMP STRUCTURE

(71) Applicant: YU LUO, SHENZHEN (CN)

(72) Inventor: YU LUO, SHENZHEN (CN)

(21) Appl. No.: 15/678,458

(22) Filed: Aug. 16, 2017

(51) Int. Cl. F21K 9/232; F21K 9/235; F21V 29/74

(52) U.S. Cl. CPC F21K 9/232; F21V 29/74; F21K 9/235

(57) ABSTRACT

The present invention relates to a lamp structure, which comprises a lamp cap and a plurality of first light-emitting modules. The lamp includes a body and a plurality of first connecting structures. The plurality of first connecting structures surround the top surface of the body. Each first connecting structure includes a first fixing member and a first conductive hole. Each first light-emitting module includes a first connecting terminal at one end. The first connecting end includes a second fixing member and a second conductive hole. The first fixing member is fixed to the second fixing member. The first conductive hole communicates with the second conductive hole. Thereby, the lamp structure may be disassembled and assembled conveniently.

### FIELD OF THE INVENTION

The present invention relates generally to a lamp, and particularly to an assemblable lamp structure.

### BACKGROUND OF THE INVENTION

The lamp is one of human's most important inventions. It provides people with tremendous convenience. As technologies advance day by day, there are various commercial lamp models with respective distinguishing features. No matter incandescent lamps, fluorescent lamps, halogen lamps, electrodeless fluorescent lamps, mercury-free fluorescent lamps, and light-emitting diode (LED) lamps, they all own specific optical, safety, environment characteristics and cost-to-performance ratios. In particular, LED lamps have strong potential advantages. Hence, their applications as well as market share will expand rapidly.

As the lighting technologies develop, the evaluation on future lighting source is not placed on the luminous efficacy only. The evaluations on the lighting effect, comfort, biological effects, safety, environment characteristics, resource consumption are stressed as well. In addition, due to their advantages of low power consumption and long lifetime, no matter public or domestic lighting, LEDs have gradually replaced general commercial incandescent and power-saving lamps. The related products of LEDs are also being developed prosperously.

According to the prior art, the light emitted by the LED chips in an LED lamp structure is directional. Thereby, other structures or devices are required to scatter the light and hence enabling the light from the LED lamp structure more uniform instead of being concentrated. Alternatively, a plurality of LED chips are adopted and disposed spanning 360 degrees in a lamp structure. Thereby, the optical path of the light emitted by the LED chips may cover the surroundings uniformly. Unfortunately, changes on the light emitted by the LED lamp structures as described above are still quite limited. Besides, the LED lamp structures according to the prior art are mostly fixed, resulting in little changes on light illumination.

The drawback of the LED lamp structures according to the prior art is their inflexible usage caused by their fixed structures. Accordingly, the present invention provides a lamp structure to solve the drawback in the prior art.

### SUMMARY

An objective of the present invention is to provide a lamp structure for easy assembling and disassembling the lamp.

Another objective of the present invention is to provide a lamp structure. The partially damaged light-emitting module in the lamp structure may be repaired and thus reducing the maintenance cost.

A further objective of the present invention is to provide a lamp structure. The number of the light-emitting modules in the lamp structure may be changed according to users' requirements. Thereby, users' demand may be met.

The present invention provides a lamp structure, which comprises a lamp cap and a plurality of first light-emitting modules. The lamp includes a body and a plurality of first connecting structures. The plurality of first connecting structures surround the top surface of the body. Each first connecting structure includes a first fixing member and a first conductive hole. Each first light-emitting module includes a first connecting terminal at one end. The first connecting end includes a second fixing member and a second conductive hole. The first fixing member is fixed to the second fixing member. The first conductive hole communicates with the second conductive hole.

According to an embodiment of the present invention, each first light-emitting module further includes a first lamp base, a first lamp plate, and a first lampshade. The first lamp base includes a first lamp recess. The first lamp plate is disposed in the first lamp recess of the first lamp base. The first lampshade covers the first lamp plate and disposed on the first lamp base.

According to an embodiment of the present invention, the first lampshade includes a plurality of buckle members on the periphery. The first lamp base includes a plurality of buckle holes corresponding to the plurality of buckle members and located on the periphery of the first lamp recess. The plurality of buckle members of the first lampshade buckle into the plurality of buckle holes in the lamp base.

According to an embodiment of the present invention, the first light-emitting module further includes a first heat dissipating structure disposed on the side of the first lamp base opposite to the first lamp recess.

According to an embodiment of the present invention, the first heat dissipating structure includes a plurality of heat dissipating fins arranged in parallel on the left and right sides.

According to an embodiment of the present invention, the lamp structure further comprises a second light-emitting module, which includes a plurality of second connecting structures. The other end of each first light-emitting module includes a second connecting end. The second light-emitting module is connected to the plurality of first light-emitting modules. Besides, the plurality of second connecting structures are connected to the plurality of second connecting ends, respectively.

According to an embodiment of the present invention, each second light-emitting module further includes a second lamp base, a second lamp plate, and a second lampshade. The second lamp base includes a second lamp recess. The second lamp plate is disposed in the second lamp recess of the second lamp base. The second lampshade covers the second lamp plate and disposed on the second lamp base.

According to an embodiment of the present invention, the second light-emitting module further includes a second heat dissipating structure disposed on the side of the second lamp base opposite to the second lamp recess.

According to an embodiment of the present invention, the second heat dissipating structure includes a plurality of heat dissipating members arranged radially.

According to an embodiment of the present invention, the lamp structure further comprises a circuit tube with one end disposed at the lamp cap and the other end disposed at the second light-emitting module.

### BRIEF DESCRIPTION OF THE DRAWINGS

FIG. 1 shows a stereoscopic diagram of the lamp structure according to the first embodiment of the present invention;

FIG. 2 shows an exploded view of the lamp structure according to the first embodiment of the present invention;

FIG. 3 shows another exploded view of the lamp structure according to the first embodiment of the present invention; and

FIG. 4 shows a stereoscopic diagram of the lamp structure according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

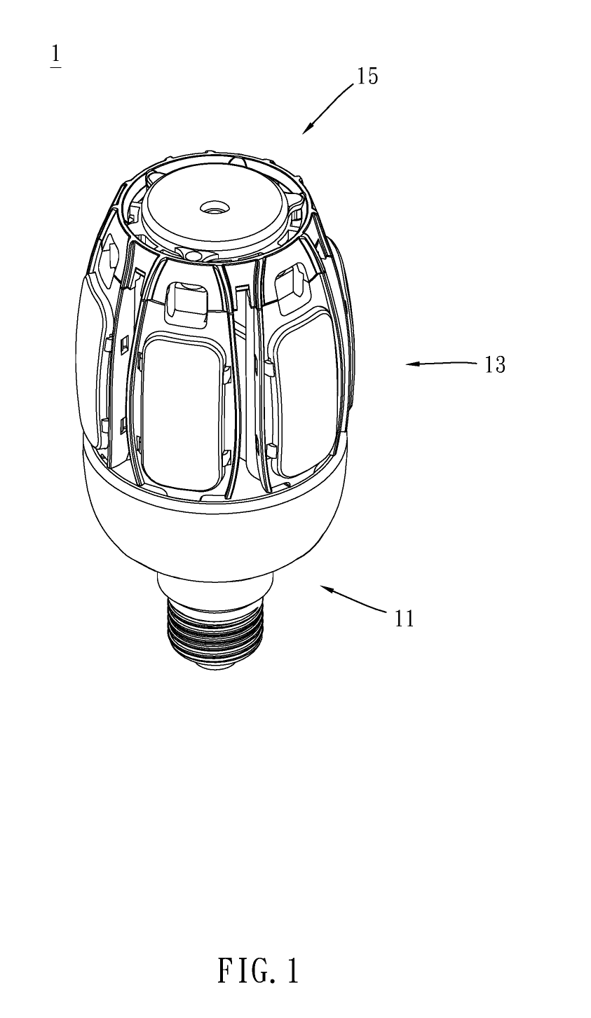

Please refer to FIG. 1, which shows a stereoscopic diagram of the lamp structure according to the first embodiment of the present invention. As shown in the figure, the present embodiment provides a lamp structure 1 formed by multiple light-emitting modules. The lamp structure 1 may be assembled and disassembled with ease. According to the present embodiment, the lamp structure 1 comprises a lamp cap 11, a plurality of first light-emitting modules 13, and a plurality of second light-emitting modules 15.

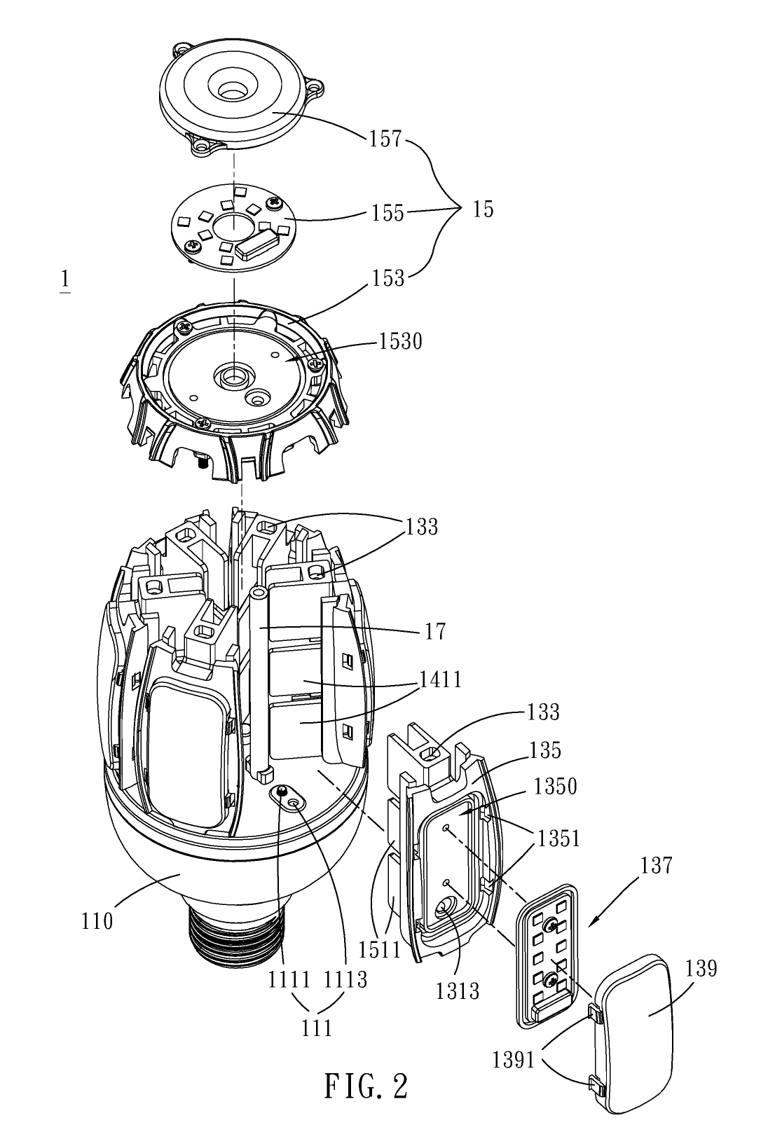

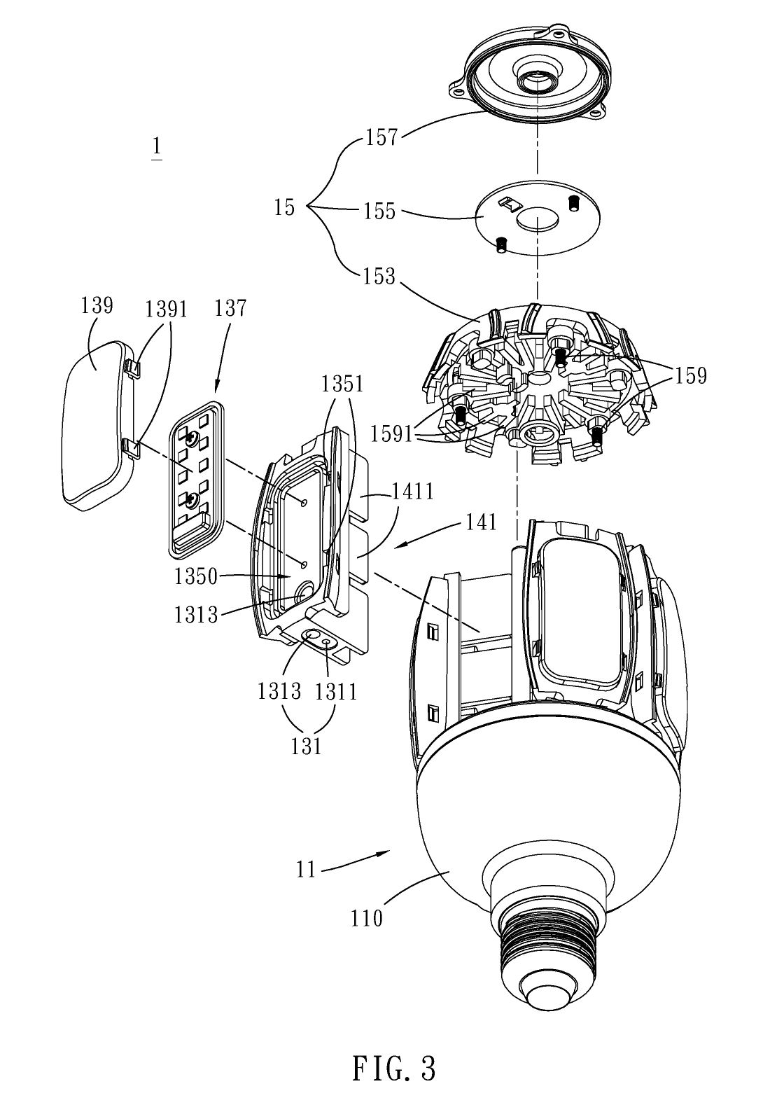

Please refer to FIG. 2 and FIG. 3, which show exploded views of the lamp structure according to the first embodiment of the present invention. As shown in the figures, the lamp cap 11 includes a body 110 and a plurality of first connecting structures 111. The plurality of first connecting structures 111 surround the top surface of the body 110. The opposing two ends of each first light-emitting module 13 includes a first connecting end 131 and a second connecting end 133, respectively. The plurality of first light-emitting modules 13 are disposed on the lamp cap 11. The plurality of first connecting ends 131 are connected to the plurality of first connecting structures 111, respectively. The second light-emitting module 15 includes a plurality of second connecting structures 151. The second light-emitting module 15 is connected to the plurality of first light-emitting modules 13. The plurality of second connecting ends 133 correspond to the plurality of second connecting structures 151, respectively.

According to the present embodiment, the lamp cap 11 includes an accommodating space therein (not shown in the figures). The accommodating space of the lamp cap 11 includes electronic components of a control circuit (not shown in the figures). The first connecting structure 111 of the lamp cap 11 include a first fixing member 1111 and a first conductive hole 1113. The first conductive hole 1113 passes through the lamp cap 11, and hence the first conductive hole 1113 communicates with the accommodating space of the lamp cap 11. In addition, the first fixing member 1111 is a fastening component such as a screw or a nail.

Moreover, the first light-emitting module 13 further includes a first lamp base 135, a first lamp plate 137, and a first lampshade 139. The first lamp base 135 includes a first lamp recess 1350. The first lamp plate 137 is disposed in the first lamp recess 1350 of the first lamp base 135. The first lamp plate 137 includes a plurality of LEDs. The first lampshade 139 includes a plurality of buckle members 1391 on the periphery. The first lamp base 135 and includes a plurality of buckle holes 1351 corresponding to the plurality of buckle members 1391. The plurality of buckle holes 1351 are located on the periphery of the first lamp recess 1350. The plurality of buckle members 1391 of the first lampshade 139 buckle into the plurality of buckle holes 1351 of the first lamp base 135. Thereby, the first lampshade 139 covers the first lamp plate 137 and disposed on the first lamp base 135. Nonetheless, the method for fixing the first lampshade 139 to the first lamp base 135 according to the present invention is not limited. Methods such as buckling, wedging, or pasting may all be adopted. The first connecting end 131 of the first light-emitting module 13 includes a second fixing member 1311 and a second conductive hole 1313. The second conductive hole 1313 passes through the first lamp base 13, from the outer surface of the first lamp base 13 to the bottom of the first lamp recess 1350.

The first member 1111 of the first connecting structure 111 is fastened to the second fixing member 1311 of the first connecting end 131. The first conductive hole 1113 of the first connecting structure 111 communicates with the second conductive hole 1313 of the first connecting end 131. The accommodating space of the lamp cap 11 communicates with the first lamp recess 1350 of the first light-emitting module 13.

Thereby, the control circuit in the accommodating space may be connected electrically with the first lamp plate 137 in the first lamp recess 1350 via the first and second conductive holes 1113, 1313.

In addition, the first light-emitting module 13 further includes a first heat dissipating structure 141 disposed on the side of the first lamp base 135 opposite to the first lamp recess 1350. The first heat dissipating structure 141 includes a plurality of heat dissipating fins 1411 arranged in parallel on the left and right sides. Thereby, the overall heat dissipating area may be increased by using the plurality of heat dissipating fins 1411 of the first heat dissipating structure 141.

According to the present embodiment, the second light-emitting module 15 further includes a second lamp base 153, a second lamp plate 155, and a second lampshade 157. The second lamp base 153 includes a second lamp recess 1530. The second lamp plate 155 is disposed in the second lamp recess 1530 of the second lamp base 153. The second lampshade 157 covers the second lamp plate 155 and is disposed on the second lamp base 153. The plurality of second connecting structures 151 of the second light-emitting module 15 are connected to the plurality of second connecting ends 133 of the plurality of first light-emitting modules 13. Besides, the lamp structure 1 comprises a circuit tube 17 with one end disposed at the lamp cap 11 and the other end disposed at the second light-emitting module 15. The circuit tube 17 communicates with the accommodating space of the lamp cap 11 and the second lamp recess 1530 of the second lamp base 153 of the first light-emitting module 13. The control circuit of the lamp cap 11 is connected electrically to the second lamp plate 155 of the second light-emitting module 15.

The second light-emitting module 15 further includes a second heat dissipating structure 159 disposed on the side of the second lamp base 153 opposite to the second lamp recess 1530. The second heat dissipating structure 159 includes a plurality of heat dissipating members 1591 arranged radially.

The present embodiment improves the drawbacks of the prior art. The LED lamps according to the prior art are mostly an integral structure. While repairing, the whole structure should be repaired or replaced, leading to high costs. In addition, the light intensity of the lamp structures according to the prior art cannot be adjusted easily according to users' requirements. Accordingly, the present invention provides a lamp structure 1, which comprises the lamp cap 11, the plurality of first light-emitting modules 13, and the second light-emitting module 15. The lamp cap 11, the plurality of first light-emitting modules 13, and the second light-emitting module 15 are assembled sequentially. Thereby, the overall structure of the lamp structure 1 may be disassembled and assembled conveniently. Furthermore, while maintaining the lamp structure 1, only the damaged portion should be repaired or replaced, and hence reducing the maintenance cost.

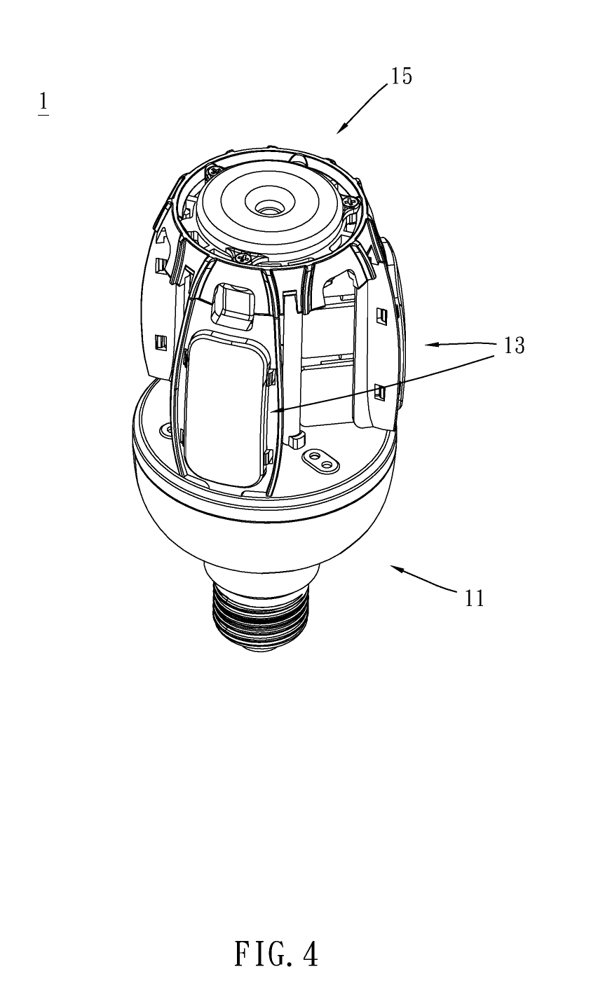

Please refer to FIG. 4, which shows a stereoscopic diagram of the lamp structure according to the second embodiment of the present invention. As shown in the figure, according to the present embodiment, the lamp cap 11, the plurality of first light-emitting modules 13, and the second light-emitting module 15 are assembled sequentially. The number of the plurality of first light-emitting modules 13 may be adjusted according to users' requirements. The difference between the present embodiment and the first one is that the number of the plurality of first light-emitting modules 13 according to the present embodiment is three. The light intensity will be weaker and thus reducing the electrical power consumption. According to the present embodiment, the number of the plurality of first light-emitting modules 13 may be adjusted freely for adjusting the light intensity of the lamp structure 1.

To sum up, the lamp structure according to the present invention comprises the lamp cap, the first light-emitting modules, and the second light-emitting module, which are assembled sequentially to form the lamp structure. Thereby, the overall structure of the lamp structure may be disassembled and assembled with ease. In addition, while maintaining the lamp structure, only the damaged portion should be repaired or replaced, and hence reducing the maintenance cost.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A lamp structure, comprising:
a lamp cap, having a body and a plurality of first connecting structures, said plurality of first connecting structures surrounding the top surface of said body, and each said first connecting structure having a first fixing member and a first conductive hole; and
a plurality of first light-emitting modules, one end of each said first light-emitting module having a first connecting end, said first connecting end having a second fixing member and as second conductive hole, said first fixing member fastened to said second fixing member, and said first conductive hole communicating with said second conductive hole.

2. The lamp structure of claim 1, wherein each said first light-emitting module further includes a first lamp base, a first lamp plate, and a first lampshade; said first lamp base includes a first lamp recess; said first lamp plate is disposed in said first lamp recess of said first lamp base; and said first lampshade covers said first lamp plate and is disposed on said first lamp base.

3. The lamp structure of claim 2, wherein said first lampshade includes a plurality buckle member on the periphery; said first lamp base includes a plurality of buckle holes corresponding to said plurality of buckle members; said plurality of buckle holes are located on the periphery of said first lamp recess; and said plurality of buckle members of said first lampshade buckle to said plurality of buckle holes of said first lamp base.

4. The lamp structure of claim 2, wherein said first light-emitting module further includes a first heat dissipating structure disposed on the side of said first lamp base opposite to said first lamp recess.

5. The lamp structure of claim 4, wherein said first heat dissipating structure includes a plurality of heat dissipating fins arranged in parallel on the left and right sides.

6. The lamp structure of claim 1, further comprising a second light-emitting modules, said second light-emitting module including a plurality of second connecting structures, the other end of each said first light-emitting module having a second connecting end, said second light-emitting module connecting to said plurality of first light-emitting modules, and said plurality of second connecting structures connecting to said plurality of second connecting ends, respectively.

7. The lamp structure of claim 6, wherein said second light-emitting module further includes a second lamp base, a second lamp plate, and a second lampshade; said second lamp base includes a second lamp recess; said second lamp plate is disposed in said second lamp recess of said second lamp base; and said second lampshade covers said second lamp plate and is disposed on said second lamp base.

8. The lamp structure of claim 6, wherein said second light-emitting module further includes a second heat dissipating structure disposed on the side of said second lamp base opposite to said second lamp recess.

9. The lamp structure of claim 8, wherein said second heat dissipating structure includes a plurality of heat dissipating members arranged radially.

10. The lamp structure of claim 1, further comprising a circuit tube with one end disposed at said lamp cap and the other end disposed at said second light-emitting module.
